(19) United States
(12) Patent Application Publication
(10) Pub. No.: US 2019/0380288 A1
(43) Pub. Date: Dec. 19, 2019

(54) PLANT CULTIVATION DEVICE

(71) Applicant: VERITABLE, LYAS (FR)

(72) Inventors: Nicolas GEHIN, Caluire-et-Cuire (FR); Chloé VERNEUIL, Caluire-et-Cuire (FR)

(21) Appl. No.: 16/464,038

(22) PCT Filed: Nov. 23, 2017
(86) PCT No.: PCT/FR2017/053233

§ 371 Date: May 24, 2019

(30) Foreign Application Priority Data
Nov. 25, 2016 (FR) 16/61528

(51) Int. Cl. A01G 27/02; A01G 7/04

(52) U.S. Cl. CPC A01G 27/02; A01G 7/045

(57) ABSTRACT

The invention concerns a plant cultivation device. The device comprises a receptacle having at least one peripheral wall and a bottom wall. The bottom wall has at least one hole opening into an irrigation tube, a region of the bottom wall around the, or each, hole comprising guide means adapted to guide roots of a plant around the corresponding hole to keep the irrigation tube substantially clear.

The invention also concerns a cartridge comprising a substrate, adapted to be positioned in this receptacle, the cartridge having a lower face comprising at least one relief adapted to cooperate with the guide means of the receptacle.

### CROSS REFERENCE TO RELATED APPLICATIONS

This application is a National Stage of PCT Application No. PCT/FR2017/053233 filed on Nov. 23, 2017, which claims priority to French Patent Application No. 16/61528 filed on Nov. 25, 2016, the contents each of which are incorporated herein by reference thereto.

### TECHNICAL FIELD

The present invention concerns a plant cultivation device.

### BACKGROUND

It is known to cultivate plants in pots. Unlike cultivation in open ground, this cultivation method may require a more significant irrigation. Indeed, the substrate present in the pot does not have a sufficient thickness to retain water. A classic solution consists in regularly irrigating by pouring water on the substrate. However, this irrigation method tends to lixiviate the substrate.

In order to overcome this problem, it is known to use a receptacle at the bottom of which irrigation tubes open, which receptacle is itself placed in a tank containing water. The irrigation is then done by the bottom of the substrate, by capillarity, without the risk of water flushing all the nutrients of the substrate.

However, it is common for the roots of plants to rush into the irrigation tubes and obstruct them. This is undesirable for several reasons: this hinders the rise of water towards the plant, as well as the gas exchanges required for the proper growth of the plants at the root level; this may interfere with the operation of some components of the whole plant cultivation system, for example the float allowing detecting the level of water in the tank; moreover, the roots may form an entangled network preventing the easy removal of the substrate carrying the plant, when the user wishes so.

### BRIEF SUMMARY

In this technical context, the object of the present invention is to provide a plant cultivation device allowing keeping the irrigation tubes substantially clear off the roots.

According to a general definition, the invention concerns a plant cultivation device which comprises a receptacle having at least one peripheral wall and one bottom wall. The bottom wall has at least one hole opening into an irrigation tube. A region of the bottom wall around the, or each, hole comprises guide means adapted to guide roots of a plant around the corresponding hole to keep the irrigation tube substantially clear. The guide means comprise at least one rib adapted to guide the roots of a plant, the or each rib projecting from the bottom wall towards the inside of the receptacle, at least one rib partially surrounding the corresponding hole by creating an area which surrounds the hole and by leaving an opening, so as to enable the roots to rotate around the hole by substantially following the or each rib then to come out from the guide means.

In a particularly advantageous manner, the guide means allow diverting the roots from the hole so as to keep the irrigation tube clear. In other words, the guide means allow preventing the roots from obstructing the irrigation tube.

Concretely, in order to create an area which surrounds the hole, the or each rib is not located on the edge of the hole, but at a distance from the hole. The opening enables the roots that would have approached the hole by passing through the opening or from above the rib to come out from the space formed by the guide means, after having grown by substantially following the rib, on the inner side of this space.

According to a possible embodiment, in order to prevent the roots from entering the area formed by the rib and surrounding the hole, and/or in order to enable the roots that would have entered this zone to come out therefrom, one and/or the other of the following arrangements may be provided:
the ratio L/d of the width of the opening to the diameter of the hole is comprised between L/d min and L/d max, where L/d min is equal to 1, preferably 1.3, and L/d max is equal to 2.7, preferably 2.5, preferably 2;
the angular sector having as a vertex the center of the hole and delimited by half-lines passing through the ends of the opening forms an angle (α) comprised between αmin and αmax, where αmin is equal to 35°, preferably 45°, preferably 55°, and αmax is equal to 90°, preferably 80°, preferably 70°.

At least one rib may have a substantially horseshoe-like shaped geometry, that is to say, generally C-shaped.

The, or each, substantially horseshoe-like shaped rib may comprise a curved portion positioned around the hole and having two ends, and two substantially parallel branches each forming an extension of one end of the curved portion, so that the opening forms a section narrowing. The section narrowing allows limiting the entry of the roots into the guide means.

At least one rib may have a substantially rectilinear geometry.

The guide means may comprise three substantially rectilinear ribs, arranged to substantially form a U-shape.

The U-shape may comprise two lateral ribs and a base rib, the base rib having a height with respect to the bottom wall larger than the height of the lateral ribs with respect to the bottom wall.

At least one rib may have at least one face oblique with respect to the bottom wall. The oblique face allows facilitating the course of the roots by enabling them to pass above the rib, by forming some kind of ramp.

The guide means may comprise a collar encircling the hole, for example in the immediate vicinity of the contour of the hole. The collar constitutes an additional means allowing diverting the roots from the hole.

The invention also relates to a cartridge comprising a substrate, adapted to be positioned in a receptacle as previously described, and which has a lower face comprising at least one relief adapted to cooperate with the guide means of the receptacle.

It is specified that, in the present document, the term «substrate» means a cultivation support composed of materials which may be organic (such as for example coconut fiber or peat) or inorganic (such as for example rock wool) in which a plant can draw the elements necessary for its growth (minerals, water, gas, etc.).

The presence on the cartridge of at least one relief adapted to cooperate with the guide means of the receptacle enables the cartridge to be mounted in a device according to the invention, and to fully benefit from the advantages conferred by the guide means of the receptacle. The term «adapted» means that the relief and the guide means can cooperate, without necessarily requiring a similarity of the shapes of these two elements. Concretely, the cooperation between the relief and the guide means may be translated in either one of the following ways:
the relief is at least partially housed within, or at least partly houses, the guide means. In particular, if the guide means create an area which surrounds the hole formed in the bottom wall of the receptacle and which is provided with an opening, the relief may occupy at least partially said area; the relief may further extend beyond the area by passing through the opening; a single relief may be provided to cooperate with several ones of these areas, or a given relief may cooperate with only one of these areas;
the relief is shaped to allow the irrigation of the cartridge, that is to say that, when the cartridge is placed in the receptacle, it enables the rise of water via the irrigation tube, up to the cartridge. The relief may thus be defined as an «irrigation relief». To this end, preferably, a lower portion of the cartridge is in contact with or in the immediate vicinity of the hole, when the cartridge is placed in the receptacle; it may be the lower face of the relief, for example if it is projecting with respect to the lower face of the cartridge; alternatively, it may be the lower face of the cartridge, for example substantially planar and in contact with the bottom wall of the receptacle, if the relief is an imprint inwardly recessed relative to said lower face of the cartridge.
concretely, the cartridge may «fit into» into the guide means, whether their respective shapes are substantially identical or only compatible for a cooperation.

At least one relief may be an imprint, and/or at least one relief may be a projection.

At least one relief may have a geometry complementary to the geometry of the guide means. It is specified that in the present document, the term «complementary geometry» means a geometry corresponding to a mirror image of the guide means.

At least one relief may have a substantially horseshoe-like shaped imprint complementary to the geometry of the substantially horseshoe-like shaped rib.

The cartridge may comprise at least one plant seed. The, or each, plant seed may be disposed in at least one housing opening to the outside of the cartridge. The, or each, housing may be sealed by a lid fastened to the cartridge, for example formed by a sheet having at least one glue dot allowing fastening the sheet to the cartridge.

Moreover, the cartridge may comprise at least one fertilizer product.

The invention also relates to a set which comprises a device, for example as previously described and a cartridge, for example of the previously described type.

The invention also relates to a plant cultivation system which comprises:
a tank having an upper opening, the tank being intended to contain water;
a tray disposed at the level of the upper opening of the tank and having an aperture;
at least one mast supporting at least one light source;
at least one set according to the invention, disposed in the tank and received in the aperture.

### BRIEF DESCRIPTION OF THE DRAWINGS

Other features and advantages of the invention will become apparent from the following description in connection with the appended drawings.

FIG. 1 is a partial perspective view of a plant cultivation device according to the invention;

FIG. 2 is a detailed perspective view of an embodiment of the guide means according to the invention;

FIGS. 3 to 8 are schematic views of different embodiments of the guide means according to the invention;

FIG. 9 is a perspective view of a cartridge according to the invention having a relief according to an embodiment;

FIG. 10 is a schematic perspective view of another embodiment of the relief of a cartridge according to the invention;

FIG. 11 is a perspective view of a cartridge according to the invention;

FIG. 12 is a perspective view of a set according to the invention, comprising a plant cultivation device and a cartridge;

FIG. 13 is a sectional view of the set of FIG. 12;

FIG. 14 is a perspective view of a cultivation system according to the invention.

### DETAILED DESCRIPTION

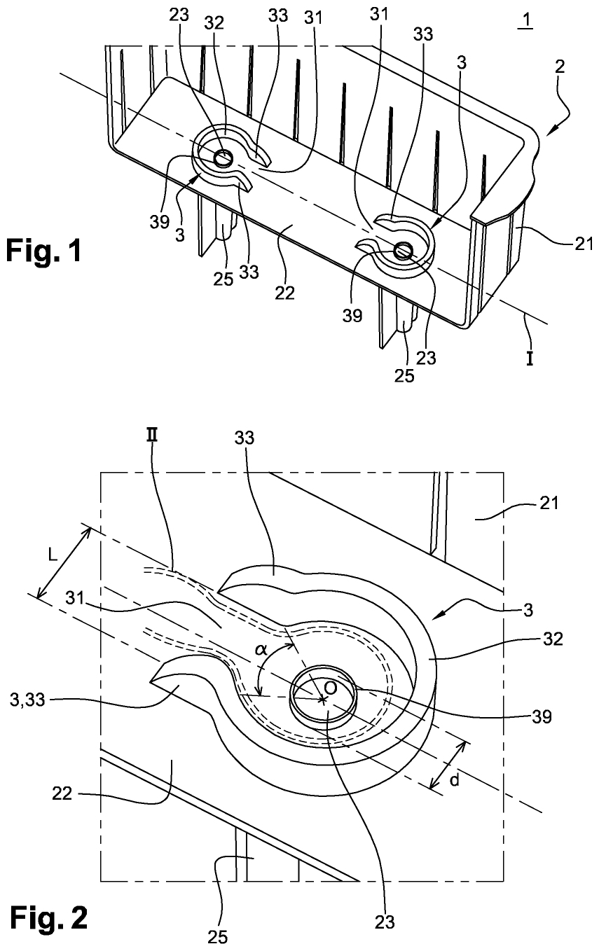

Referring to FIG. 1, the invention concerns a plant cultivation device 1 which comprises a receptacle 2.

The receptacle 2 is intended to be placed in a plant cultivation system 100 as represented in FIG. 14. This system 100 comprises:
a tank 101 having an upper opening, the tank being intended to contain water;
a tray 102 disposed at the level of the upper opening of the tank 101 and having one or several aperture(s) 103;
at least one mast 104 supporting at least one light source 105;
a receptacle 2 disposed in the tank 101 and received in each of the apertures 103, the receptacle 2 being adapted to receive a cartridge 5 to allow the cultivation of a plant.

The receptacle 2 has a peripheral wall 21 and a bottom wall 22. According to the examples presented herein, the receptacle 2 has a substantially rectangular parallelepiped geometry, with a longitudinal axis I. According to other embodiments, the receptacle 2 could for example be cubic, cylindrical or of any prismatic shape.

The receptacle 2 may be made of a polymer material or aluminum, or another material.

According to the example presented herein, the bottom wall 22 has two holes 23 each opening into an irrigation tube 25 which may contain a wick (not represented) enabling the rise of water, by capillarity, from the tank 101 to the receptacle 2 and the cartridge 5. According to other embodiments, the bottom wall 22 may have a smaller or larger number of holes 23.

A region of the bottom wall around each hole 23 comprises guide means adapted to guide roots of the plant—having grown in the cartridge 5—around the hole 23, so as to keep the irrigation tube 25 substantially clear. In other words, the guide means allow preventing the roots from obstructing the irrigation tube 25.

Referring to FIGS. 2 to 8, the guide means may comprise at least one rib 3 adapted to guide the roots of a plant, this rib 3 projecting towards the inside of the receptacle 2.

The rib 3 may partially surround the hole 23 while leaving an opening 31 enabling the roots II to rotate around the hole 23 following the guide means. The opening 31 enables the roots II to come out after they have grown by substantially following the guide means.

In FIG. 2 the diameter d of the hole 23, the width L of the opening 31, as well as the angle α of the angular sector having as a vertex the center O of the hole 23 and delimited by half-lines passing through the ends of the opening 31 are represented. In this embodiment, L/d is for example comprised between 1 and 2, for example about 1.5. As for α, it may be comprised between 45° and 65°, for example about 55°.

According to an embodiment shown in FIG. 2, the guide means comprise a substantially horseshoe-like shaped rib 3. The horseshoe-like shaped rib 3 comprises a curved portion 32 positioned around the hole 23, which may have the shape of a circle portion extending over more than a half-turn, for example over three-quarter turn. The curved portion 32 has two ends. In addition, the rib 3 comprises two substantially parallel branches 33 each forming an extension of one end of the curved portion 32, so that the opening 31 forms a section narrowing.

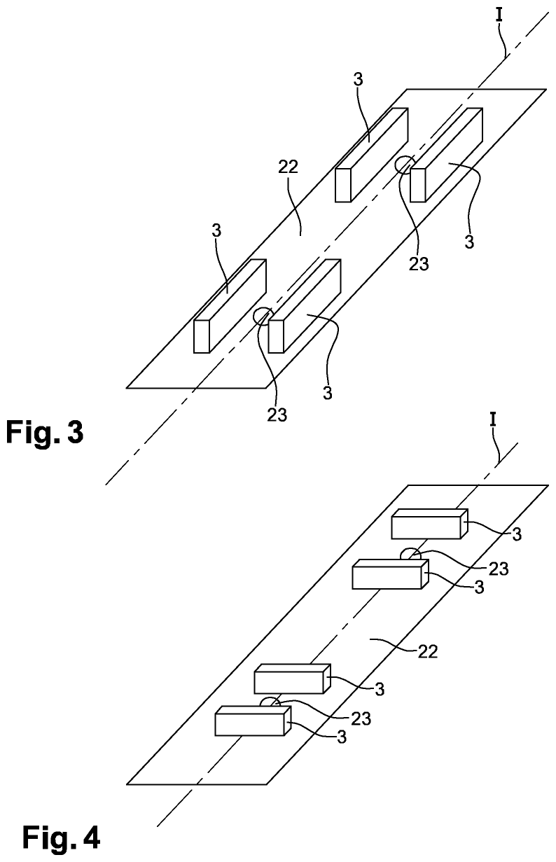

According to other embodiments shown in FIGS. 3 to 8, each rib 3 has a substantially rectilinear geometry.

Referring to FIGS. 3 and 4, the guide means may comprise two rectilinear ribs 3 parallel to each other and disposed on either side of the hole 23. The ribs 3 may be parallel to the longitudinal axis I (as represented in FIG. 3) or may be substantially perpendicular to the longitudinal axis I (as represented in FIG. 4).

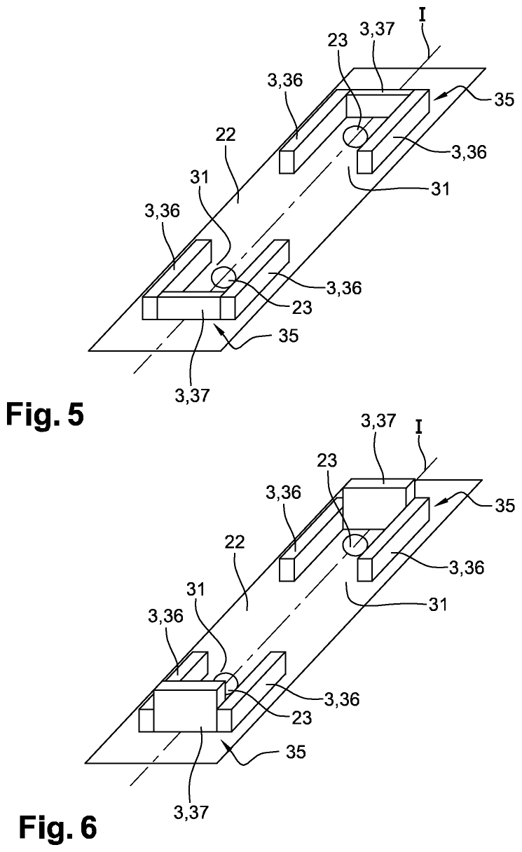

According to other embodiments represented in FIGS. 5 to 8, the guide means may comprise three substantially rectilinear ribs 3, arranged to substantially form a U-shape 35. The U-shape 35 may comprise two lateral ribs 36 and a base rib 37. The U-shape 35 has an opening 31.

According to the embodiment shown in FIG. 6, the base rib 37 may have a height with respect to the bottom wall 22 larger than the height of the lateral ribs 36 with respect to the bottom wall 22.

According to the embodiments shown in FIGS. 5 and 6, the U-shapes 35 are oriented so that their base ribs 37 are perpendicular to the longitudinal axis I and their openings 31 face each other.

According to the embodiment shown in FIG. 7, the U-shapes 35 are oriented so that their base ribs 37 are perpendicular to the longitudinal axis I and their openings 31 are opposite to each other.

In FIG. 7, the diameter d of the hole 23, the width L of the opening 31, as well as the angle α of the angular sector having as a vertex the center O of the hole 23 and delimited by half-lines passing through the ends of the opening 31 are represented. In this embodiment, L/d is for example comprised between 2 and 2.7, for example about 2.5. As for α, it may be comprised between 55° and 90°, for example about 70°.

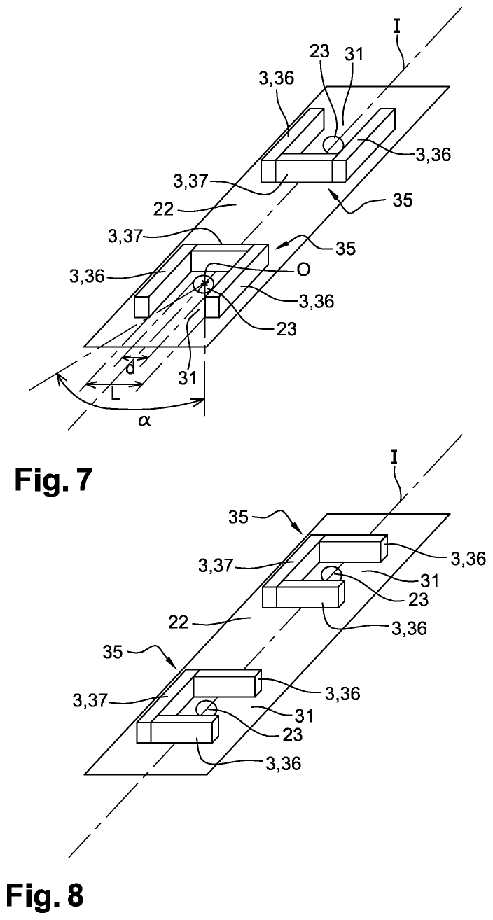

According to the embodiment shown in FIG. 8, the U-shapes 35 are oriented so that their base ribs 37 are parallel to the longitudinal axis I, the openings 31 being located on the same side.

Each rib 3 may have at least one face (not represented) oblique with respect to the bottom wall. The oblique face allows facilitating the course of the roots by enabling them to pass above the rib 3.

The guide means may comprise a collar 39 which encircles the hole 23. The collar 39 allows diverting the roots II from the hole 23.

The invention also relates to a cartridge 5 comprising a substrate, represented in FIG. 9. The cartridge 5 is adapted to be positioned in a receptacle 2 according to the invention. The cartridge 5 has a lower face 50 which comprises several reliefs 51 adapted to cooperate with the guide means.

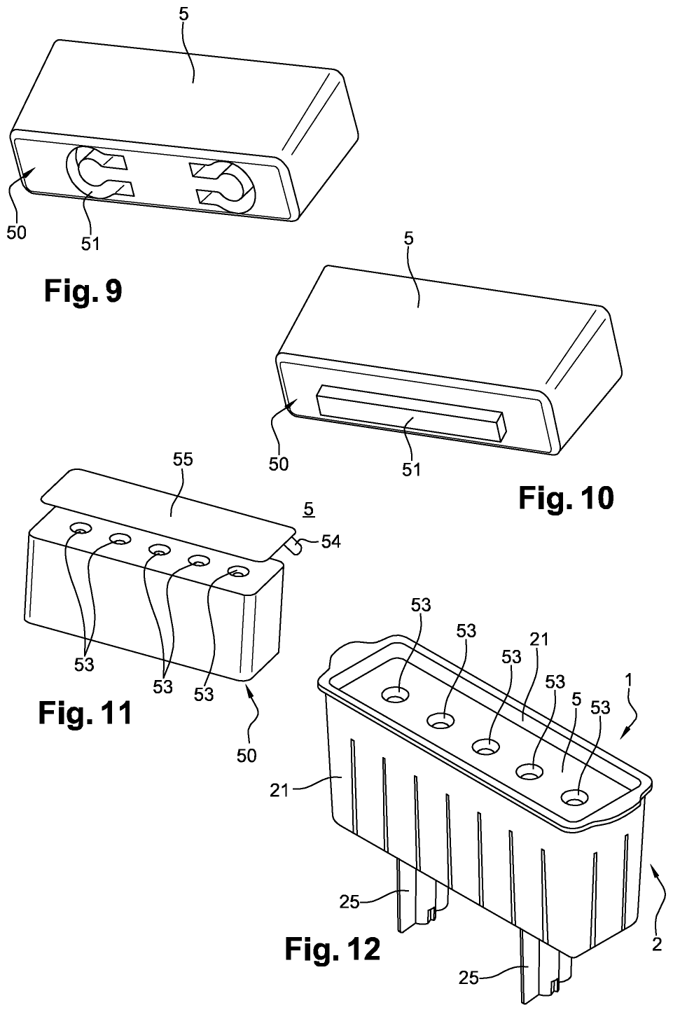

Each of these reliefs 51 may be an imprint, according to the embodiment illustrated in FIG. 9, or a projection, according to the embodiment illustrated in FIG. 10.

Furthermore, as represented in FIG. 9, the relief 51 may have a geometry complementary to the geometry of the guide means. According to the example represented in FIG. 9, the reliefs 51 are horseshoe-like shaped imprints corresponding to the geometry of the previously-described horseshoe-like shaped rib 3.

However, referring to FIG. 10, a single relief 51 in the form of a block projecting from the lower face 50 of the cartridge 5, although not having a shape complementary to that of the two horseshoe-like shaped guide means whose openings face each other, may perfectly cooperate with the receptacle illustrated in FIG. 1, by being inserted between the two guide means. Of course, such a cartridge 5 may also cooperate with the receptacles 2 illustrated in FIGS. 3, 4, 5 and 6.

The cartridge 5 may comprise at least one plant seed.

The plant seed may be mixed with the substrate, the whole being able to form some kind of a block with a homogeneous external appearance, ready for use. Alternatively, the plant seed may be planted by the user of the system 100.

According to yet another possibility, as represented in FIG. 11, each plant seed may be disposed in at least one housing 53 opening to the outside of the cartridge 5. Each housing may be sealed by a lid in the form of a sheet 55 having at least one glue dot allowing fastening the sheet 55 to the cartridge 5. Preferably, the sheet 55 is glue-free opposite the housings 53. The sheet 55 may include a tab 54 facilitating handling thereof during manufacture and when using the cartridge 5.

Each plant seed may be glued in the corresponding housing 53 to ensure holding thereof. This may be particularly useful for a small seed, in order to prevent it from slipping between the lid 55 and the substrate. Alternatively, the small seeds may be coated (according to a usual process known in the seed industry) in order to ensure that they cannot leave their housings 53.

Furthermore, the cartridge 5 may comprise at least one fertilizer product, such as a nitrogenous fertilizer, an organic fertilizer or a mineral fertilizer.

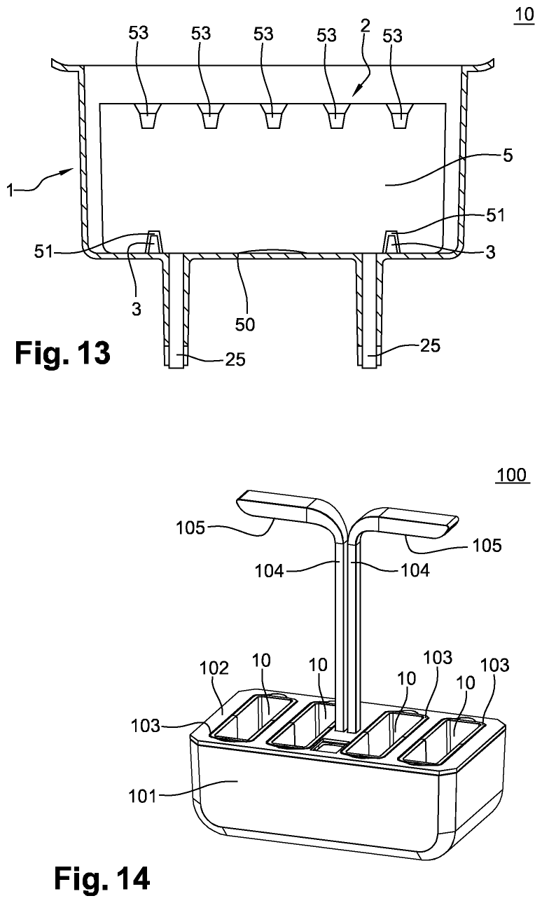

Referring to FIGS. 12 and 13, the invention also relates to a set 10 which comprises, on the one hand, a plant cultivation device 1 comprising a receptacle 2, and on the other hand, a cartridge 5 including a substrate. At least one amongst the receptacle and the cartridge 5 is in accordance with the previous description.

The fact of disposing, in a receptacle 2, a cartridge 5 whose lower face 50 comprises a relief 51 cooperating with the guide means of the receptacle 2 allows obtaining a «nesting» of the cartridge 5 into the receptacle 2. According to the relative shapes of the relief 51 and the guide means, all or part of the lower face 50 of the cartridge may be in contact with the bottom wall 22 of the receptacle 2, which improves the transfer of water to the seeds and increases the volume of the cartridge which may be housed within the receptacle 2. These advantages are even more considerable if the reliefs 51 and the guide means have corresponding shapes.

Thus, the invention proposes a plant cultivation device, a cartridge, a set and a plant cultivation system which allow keeping the irrigation tubes substantially clear off the roots, thereby ensuring a high efficiency of the water supply and an easy removal of the cartridges after use.

Of course, the invention is not limited to the embodiments described hereinabove and illustrated by the different figures, these embodiments having been provided only as example. Modifications remain possible in particular with regards to the constitution of the various elements or by the substitution of technical equivalents, yet without departing from the scope of the invention.

1. A plant cultivation device, comprising a receptacle having at least one peripheral wall and a bottom wall, the bottom wall having at least one hole opening into an irrigation tube, wherein a region of the bottom wall around the, or each, hole comprises guide means adapted to guide roots of a plant around the corresponding hole to keep the irrigation tube substantially clear, the guide means comprising at least one rib adapted to guide the roots of a plant, the or each rib projecting from the bottom wall towards the inside of the receptacle, at least one rib partially surrounding the corresponding hole by creating an area which surrounds the hole and by leaving an opening, so as to enable the roots to rotate around the hole by substantially following the or each rib then to come out from the guide means.

2. The device according to claim 1, wherein the ratio L/d of the width (L) of the opening to the diameter (d) of the hole is comprised between L/d min and L/d max, where L/d min is equal to 1, preferably 1.3, and L/d max is equal to 2.7, preferably 2.5, preferably 2.

3. The device according to claim 1, wherein the angular sector having as a vertex the center (O) of the hole and delimited by half-lines passing through the ends of the opening forms an angle (α) comprised between αmin and αmax, where αmin is equal to 35°, preferably 45°, preferably 55°, and αmax is equal to 90°, preferably 80°, preferably 70°.

4. The device according to claim 1, wherein at least one rib has a substantially horseshoe-like shaped geometry.

5. The device according to claim 4, wherein the, or each, substantially horseshoe-like shaped rib comprises a curved portion positioned around the hole and having two ends, and two substantially parallel branches each forming an extension of one end of the curved portion, so that the opening forms a section narrowing.

6. The device according to claim 1, wherein at least one rib has a substantially rectilinear geometry.

7. The device according to claim 1, wherein the guide means comprise three substantially rectilinear ribs, arranged to substantially form a U-shape.

8. The device according to claim 7, wherein the U-shape comprises two lateral ribs and a base rib, the base rib having a height with respect to the bottom wall larger than the height of the lateral ribs with respect to the bottom wall.

9. The device according to claim 1, wherein at least one rib has at least one face oblique with respect to the bottom wall.

10. The device according to claim 1, wherein the guide means comprise a collar encircling the hole.

11. A cartridge comprising a substrate, wherein the cartridge is adapted to be positioned in the receptacle of the device of claim 1, the cartridge having a lower face comprising at least one relief adapted to cooperate with the guide means of the receptacle.

12. The cartridge according to claim 11, wherein the relief is at least partially housed within, or at least partly houses, the guide means, the relief occupying preferably at least partially the area that surrounds the hole.

13. The cartridge according to claim 11, wherein at least one relief is an imprint.

14. The cartridge according to claim 11, wherein at least one relief is a projection.

15. The cartridge according to claim 11, wherein at least one relief has a geometry complementary to the geometry of the guide means.

16. The cartridge according to claim 15, wherein at least one relief has a substantially horseshoe-like shaped imprint complementary to the geometry of the substantially horseshoe-like shaped rib.

17. The cartridge according to claim 11, wherein the cartridge comprises at least one plant seed, the, or each, plant seed being disposed in at least one housing opening to the outside of the cartridge.

18. The cartridge according to claim 17, wherein the, or each, housing is sealed by a lid fastened to the cartridge.

19. (canceled)

20. A plant cultivation system, comprising:
a tank having an upper opening, the tank being intended to contain water;
a tray disposed at the level of the upper opening of the tank and having an aperture;
at least one mast supporting at least one light source;
at least one set, disposed in the tank and received in the aperture, the at least one set including a cartridge comprising a substrate, wherein the cartridge is adapted to be positioned in the receptacle of the device of claim 1, the cartridge having a lower face comprising at least one relief adapted to cooperate with the guide means of the receptacle.

21. The device according to claim 2, wherein the angular sector having as a vertex the center (O) of the hole and delimited by half-lines passing through the ends of the opening forms an angle (α) comprised between αmin and αmax, where αmin is equal to 35°, preferably 45°, preferably 55°, and αmax is equal to 90°, preferably 80°, preferably 70°.
